(19) United States
(12) Patent Application Publication
(10) Pub. No.: US 2022/0277569 A1
(43) Pub. Date: Sep. 1, 2022

(54) METHOD FOR DETERMINING A FUSED SENSOR DETECTION CONDITION

(71) Applicant: Robert Bosch GmbH, Stuttgart (DE)

(72) Inventors: Andreas Heyl, Weil Der Stadt (DE); Roman Gansch, Renningen (DE)

(21) Appl. No.: 17/651,978

(22) Filed: Feb. 22, 2022

(30) Foreign Application Priority Data
Feb. 26, 2021 (DE) 10 2021 104 662.9

(51) Int. Cl. G06V 20/58; B60W 30/08

(52) U.S. Cl. CPC G06V 20/58; B60W 30/08; B60W 2420/52; B60W 2420/42; B60W 2552/20

(57) ABSTRACT

A method for determining an evaluated detection condition for an evaluation of sensor data. The method includes: providing a first integrity value of the detection condition, based on a first basis for determining the detection condition; providing a second integrity value of the detection condition, based on a second basis for determining the detection condition; determining an overall integrity value for the detection condition, based on the first integrity value and the second integrity value; assigning the overall integrity value to the detection condition for determining the evaluated detection condition.

### CROSS REFERENCE

The present application claims the benefit under 35 U.S.C. § 119 of German Patent Application No. DE 10 2021 104 662.9 filed on Feb. 26, 2021, which is expressly incorporated herein by reference in its entirety.

### BACKGROUND INFORMATION

The automation of driving goes hand in hand with the equipment of vehicles with increasingly more comprehensive and more powerful sensor systems for detecting the surroundings. To some extent, vehicle sensors redundantly cover 360° of the surroundings and different ranges with the aid of multiple sensors and sensor modalities. For example, video, radar, LIDAR, ultrasonic and microphone sensors are used as sensor modalities.

Sensor data are fused into a secured surroundings model to represent surroundings of the vehicle. Requirements for the scope and quality of the surroundings model, in turn, depend on the driving functions implemented thereon. In the driverless vehicle, for example, comprehensive driving decisions are made, and the actuators are activated accordingly, based on the surroundings model.

The draft standard ISO/PAS 21448 (Road Vehicles—Safety of the Intended Functionality (SOTIF)) deals with a problem, in that the performance or the capabilities and deficiencies of the exteroceptive sensors used must be taken into account in the safety concept for surroundings perception in autonomous systems (ADAS, AD). Safety-critical effects of sensor deficiencies of this type, which must be avoided, are, for example, erroneous measurements, false positives (FP) or false negatives (FN), which, in turn, may result in “triggering conditions.” ISO/PAS 21448 discusses processes, with the aid of which triggers may be identified during development and which then may be mitigated in the product.

### SUMMARY

However, a method would be advantageous, with the aid of which triggers of deficiencies could be reliably discovered during the operation of the at least partially automated vehicle and taken into account in the safety concept, in particular across sensors.

The present invention is based on determining explicit knowledge of a multiplicity of presently prevailing sensor system-impairing detection conditions in the surroundings of the sensor system and/or an at least semi-automated vehicle during operation, in a structured and easy-to-use format and to provide it for a fusion of sensor data.

The knowledge of the detection conditions provided in this manner may subsequently be used across systems for all exteroceptive sensors for evaluating the confidence of specific pieces of sensor information in the present situation, based on which, in turn, the weight of this information may be adapted in the fusion.

The safety integrity (reliability, SOTIF) of the fusion result may thus be increased and negative effects of individual deficiencies avoided, from which an increase in the robustness of the surroundings detection, as well as a faster generation of hypotheses about the surroundings, may result.

According to aspects of the present invention, a method for determining an evaluated detection condition for the fusion of sensor data, a method for the fusion of data of a first sensor system and a second sensor system, a method for providing a control signal, an evaluation device, a use of an evaluation device, a computer program, and a machine-readable memory medium are provided.

Advantageous embodiments of the present invention are disclosed herein.

In this overall description of the present invention, the sequence of method steps is illustrated in such a way that the method is easy to understand. However, in view of the disclosure herein, those skilled in the art will recognize that many of the method steps may also be completed in a different order and lead to the same or a corresponding result. In this sense, the order of the method steps may be changed accordingly. Some features are provided with numerals to improve the legibility or to make the assignment clearer, which, however, does not imply a presence of certain features.

According to one aspect of the present invention, a method is provided for determining an evaluated detection condition for an evaluation of sensor data. In accordance with an example embodiment of the present invention, the method includes the following steps:

In one step, a first integrity value of the detection condition is provided, based on a first basis for determining the detection condition. In a further step, a second integrity value of the detection condition is provided, based on a second basis for determining the detection condition. In a further step, an overall integrity value is provided for the detection condition, based on the first integrity value and the second integrity value. In a further step, the overall integrity value is assigned to the detection condition for the purpose of determining the evaluated detection condition.

An integrity value may indicate a value, which determines a reliability of an item of data of a sensor system and/or another data source as the particular basis for determining the detection condition, with reference to electrical and/or technical errors which are attributable to a hardware and/or software. The corresponding integrity value or overall integrity value may be employed to use data of different sensor systems for a fusion to determine surroundings of the particular sensor systems, in that the data of the sensor systems are evaluated accordingly. In other words, the overall integrity value may be viewed as a measure of a reliability of the determined detection condition.

In accordance with an example embodiment of the present invention, the particular integrity value may be determined with the aid of an ASIL value (automotive safety integrity level), which may be provided by sensor systems as meta data together with the sensor data to take into account these meta data in a receiving module according to a safety concept. The overall integrity value may characterize a degree of a securing, a reliability of a detection function or a quality of a result, which arises, for example, from a redundancy of the pieces of information and the individual ASIL values of the particular sensor systems.

Detection conditions may be conditions which may relate to the surroundings of a mobile platform and influence sensor systems for representing surroundings of the mobile platform with respect to a representation of the surroundings. For example, weather conditions, light conditions, temperature, reflections of transmitted signals, incident light, characteristics of the surroundings, interfering images, interfering surfaces, other road users, dynamic coverings, interfering radiation from static sources or from dynamic sources, such as road users, a complexity of the surroundings, the detection conditions being derivable as a basis from internal or external sensor data, geographic data, such as map data or infrastructure data, provided data of other road users, V2V data.

A multiplicity of detection conditions may impair the data provided by sensor systems:

Global detection conditions may impair the data provided by sensor systems, for example:
weather conditions, e.g., rain or rain density and/or snow or snow density and/or fog or fog density, etc.;
light conditions, which may be dependent on a time of day and/or dependent on a cloud cover of the sky, etc.;
proximity to an interfering radar radiation source, for example airports, military facilities); and
outdoor temperatures.

Zone-specific detection conditions may impair the data provided by sensor systems, for example:
zones with a tendency toward reflections, such as tunnel walls and/or bridges and/or guardrails and/or metal fences and/or window façades, etc.;
road, depending on surface water and/or rain quantities; and
shadows cast by dynamic or static objects, such as buildings, depending on the position of the sun.

Relative and/or local detection conditions may impair the data provided by sensor systems, for example:
concealment by objects, e.g., by buildings, trees, junction boxes, etc.;
concealment by road topography, e.g., turns, hilltops;
reflecting objects, such as traffic signs, which may influence LIDAR systems, steel plates, which may influence radar systems and are placed, for example, on a ground;
road condition, such as potholes, edges, etc.;
glare due to low sun or its reflections;
images on advertising pillars, billboards, signs; and
material/structures of other road users.

Dynamic detection conditions may furthermore impair the data provided by sensor systems, for example:
dynamic concealment, such as by other road users;
interference by radar and/or LIDAR of other road users; and
a prevailing traffic density, which may impair the resulting complexity of the sensor measurement and/or its interpretation in the case of varied and/or “intersecting” objects, etc.

The detection conditions may be based on different bases in each case and relate to surroundings of a mobile platform. One basis for a determination of detection conditions may be either provided individually or ascertained with the aid of a combination, for example, of the following sources: Sensor data may be a basis for determining detection conditions:
dedicated sensors for determining the particular detection condition, such as a rain sensor or a brightness sensor;
explicit pattern recognition with the aid of individual exteroceptive sensors, such as typical rain reflection patterns, which may be determined with the aid of a LIDAR system;
pattern recognition and interpretation by evaluating data of one or multiple sensors, for example with the aid of artificial intelligence or MLM; and
evidence, which is ascertained implicitly from the evaluation results of sensor data processing, such as in pro-processing or fusion, for example high noise.

Map data may be a basis for determining detection conditions:
static and/or dynamic map data;
numeric and/or analytical evaluation of map topography, such as a determination of shadow areas, depending on the position of the sun and/or visible areas behind a hilltop, etc.;
explicitly marked zones or objects, i.e. “points of interest,” such as tunnels, window façades; other reflecting objects; billboards having images; traffic signs with orientation angles; etc.; and
crowdsourcing (typical effects, triggers).

Infrastructure data may be a basis for determining detection conditions:

Infrastructure data, such as guidance systems; roadside units; V2I;
sensor data, as listed above, which are provided from infrastructure sensor systems;
local information, such as a reflectivity of a local road section under wet conditions; a position of reflecting objects; etc.;
information about traffic density; equipment of vehicles in the surroundings with and specific orientation of LIDAR systems and/or radar systems;
information of other road users (V2V);
information about vehicles: Equipment with and specific orientation of LIDAR systems and/or radar systems; and
other road users, in particular without AD functionality: AV-readable “markers,” such as pictographs, QRC code, radar-reflecting clothing, etc., including pieces of information.

Due to the fact that detection conditions having different bases are determined in the method and evaluated with the aid of an overall integrity value, the particular detection conditions may be secured and provided for further methods for determining surroundings of a mobile platform, and/or a sensor system to be able to be used in correspondingly safety-critical functions.

With the aid of the evaluated detection condition, triggers of deficiencies of data of different sensor systems, which are provided to an at least semi-automated mobile platform, are reliably discovered and taken into account for a security concept, in particular across sensors.

According to one aspect of the present invention, it is provided that the method for determining the evaluated detection condition includes the following steps:

In one step, a first confidence value of the detection condition is provided, the detection condition being based on the first basis for determining the detection condition. In a further step, a second confidence value of the detection condition is provided, the detection condition being based on the second basis for determining the detection condition. In a further step, an overall confidence value of the detection condition is determined, which is based on the first confidence value and the second confidence value. In a further step, the overall integrity value and the overall confidence value are assigned to the detection condition for determining the evaluated detection condition. The confidence value may indicate how probable it is that the detection condition was correctly determined.

Due to the fact that detection conditions having different bases are determined in the method and evaluated with the aid of an overall integrity value and an overall confidence value, the particular detection conditions may be secured and provided for further methods for determining surroundings of a mobile platform, and/or a sensor system.

According to one aspect of the present invention, it is provided that the determination of the overall confidence value is based on a probabilistic combination of the first confidence value and the second confidence value.

With the aid of the probabilistic combination of the confidence values, the overall confidence value may be determined, which may indicate a probability that the detection conditions determined based on different bases was determined correctly. With the aid of an overall confidence value, a determined detection condition may thus be evaluated and/or weighted for a fusion of data of sensor systems.

According to one aspect of the present invention, it is provided that the determination of the overall integrity value is based on an arithmetic function of the first integrity value and the second integrity value.

For example, the particular ASIL values (automotive safety integrity level) of the first integrity value and the second integrity value may be added up to easily determine the overall integrity value.

According to one aspect of the present invention, it is provided that the detection condition includes at least one global detection condition and/or includes at least one zone-specific detection condition, and/or includes at least one local detection condition, and/or includes at least one dynamic detection condition.

By taking into account a multiplicity of detection conditions, a signal of a sensor system may be evaluated with respect to a correctness of the surroundings variable derived therefrom of a sensor system and/or a mobile platform.

According to one aspect of the present invention, it is provided that a basis for the particular detection condition is based on data of at least one sensor dedicated to the detection condition, and/or is based on a pattern recognition for the detection condition of data of at least one exteroceptive sensor, and/or is based on a pattern recognition for the detection condition of data of at least two exteroceptive sensors, and/or is based on at least one evaluation of results of a data processing of at least one sensor, and/or is based on at least one detection condition, which is assigned to geographical data and describes surroundings of a corresponding sensor in greater detail, and/or is based on an evaluation of map topographies, and/or is based on data provided by road users in the surroundings of the corresponding sensor. By taking into account a multiplicity of bases for the particular detection condition, a signal of a sensor system may be evaluated with respect to a correctness of the surroundings variable derived therefrom of a sensor system and/or a mobile platform.

According to one aspect of the present invention, it is provided that the determination of the evaluated detection condition excludes confidence values and/or integrity values of the detection condition, whose particular basis has a critical dependency on the particular detection condition.

This makes it possible to prevent or mitigate the fact that critical dependencies or negative influences are avoided in determining the detection conditions, i.e., for example, that no sensor system is used for determining a detection condition, which has negative influences on the capability of this sensor system with respect to the determination of this detection condition.

According to one aspect of the present invention, it is provided that the evaluated detection condition is spatially assigned to a representation of surroundings of a sensor system. Since the evaluated detection condition may be different in different locations in the surroundings of a sensor system and/or a mobile platform, the method and the information content provided thereby may be improved by an assignment of the evaluated detection condition prevailing in that location in each case, so that pieces of information about the surroundings of a sensor system and/or a mobile platform provided by a sensor system are evaluated in a spatially resolved manner. For this purpose, a system of grid cells may be defined around the sensor system and/or the mobile platform, a particular evaluated detection condition being assigned to the particular grid cell, which is specific to the location of the grid cell. Such spatially resolved, evaluated detection conditions may be structured in this manner in the form of a corresponding, three-dimensional matrix for other applications and/or modules and/or systems, for example to generate surroundings of the sensor system or a mobile platform, and be provided with an easy-to-use format. In other words, weighting factors for a fusion of data of sensor systems may be easily generated by a structured matrix of this type with the aid of the evaluated direction condition specially assigned in each case.

In accordance with an example embodiment of the present invention, a method for the fusion of data of a first sensor system and a second sensor system is provided, which includes the following steps:

In one step, at least one evaluated detection condition is determined for the first sensor system and/or the second sensor system according to one of the methods described above. In a further step, the data of the first sensor system and the second sensor system are evaluated, based on the at least one evaluated detection condition, for the fusion of the data of the first sensor system and the second sensor system to determine a representation of surroundings of at least one of the two sensor systems. The first sensor system may be of the same type as the second sensor system.

Data of sensor systems may be processed in different steps for representing surroundings of a vehicle, the data being further abstracted in each processing step and ultimately being able to be combined or fused into a secured surroundings model. The common algorithms for different sensor modalities for object detection, object classification, object tracking, distance calculation, etc. may be prone to input data which are incorrect, in particular due to detection conditions from which they were determined. Typical methods for object detection and object classification may cause false determinations in these cases, due to false-positive and false-negative determinations of surroundings-specific determination variables.

With the aid of the at least one evaluated detection condition, a sensor fusion system may use pieces of information about the detection condition for the purpose of weighting the data of different sensor systems according to the present situation with respect to the detection conditions. For example, if a sensor system is then unable to recognize objects in the surroundings, or is able to do so only poorly, based on the evaluated detection condition, a failure to detect the object by this sensor system may not result in the fact that the object hypothesis posed by other sensor systems is reduced, after the detection of this object, in its probability of having correctly detected the object. This may be achieved in that a weighting of the poorly detecting sensor systems is reduced accordingly in the fusion.

According to one aspect of the present invention, it is provided that, in the method for the fusion of data, the data of the first sensor system and the data of the second sensor system are weighted based on the at least one evaluated detection condition for representing the surroundings.

A method is provided, which provides a control signal for activating an at least semi-automated vehicle, based on an evaluated detection condition determined according to one of the methods described above; and/or a warning signal for warning a vehicle occupant is provided, based on the evaluated detection condition.

The term “based on” is to be broadly understood with reference to the feature that a control signal is provided, based on an evaluated detection condition. It is to be understood in such a way that the evaluated detection condition is used for any determination or calculation of a control signal, this not ruling out the fact that other input variables are also used for this determination of the control signal. This applies accordingly to the provision of a warning signal.

Highly automated systems may, for example, introduce a transition into a safe state with the aid of a control signal of this type, in that, for example, a slow stopping on a road shoulder is carried out in an at least semi-automated vehicle.

In accordance with an example embodiment of the present invention, an evaluation device for at least one detection condition is provided, which is based on a multiplicity of bases for determining the detection condition, the evaluation device being configured with a calculation unit to carry out one of the methods described above for determining an evaluated detection condition. An evaluation device of this type may be used for the secure determination and provision of explicit knowledge about presently prevailing detection conditions, which may impair the sensor systems, in the surroundings of an at least semi-automated vehicle.

In accordance with an example embodiment of the present invention, a use of an evaluation device, as described above, is provided for the fusion of data of a first sensor system and a second sensor system for determining a representation of surroundings of at least one of the two sensor systems.

As described above, due to an evaluation device of this type, a fusion of data of sensor systems may generate a reliable result for determining a representation of surroundings of a sensor system and/or an at least semi-automated platform.

According to one aspect of the present invention, a computer program is provided, which includes commands, which, when the computer program is executed by a computer, prompt the latter to carry out one of the methods described above. A computer program of this type makes it possible to use the described method in different systems.

In accordance with an example embodiment of the present invention, a machine-readable memory medium is described, on which the computer program described above is stored. The computer program described above may be transported with the aid of a machine-readable memory medium of this type.

### BRIEF DESCRIPTION OF THE DRAWINGS

Exemplary embodiments of the present invention are illustrated with reference to FIGS. 1 and 2 and explained in greater detail below.

FIG. 1 shows a three-dimensional grid situated around a sensor for the spatial assignment of evaluated detection conditions, in accordance with an example embodiment of the present invention.

FIG. 2 shows a view of a data flow for determining evaluated detection conditions and the use thereof for the fusion of sensor data, in accordance with an example embodiment of the present invention.

### DETAILED DESCRIPTION OF EXAMPLE EMBODIMENTS

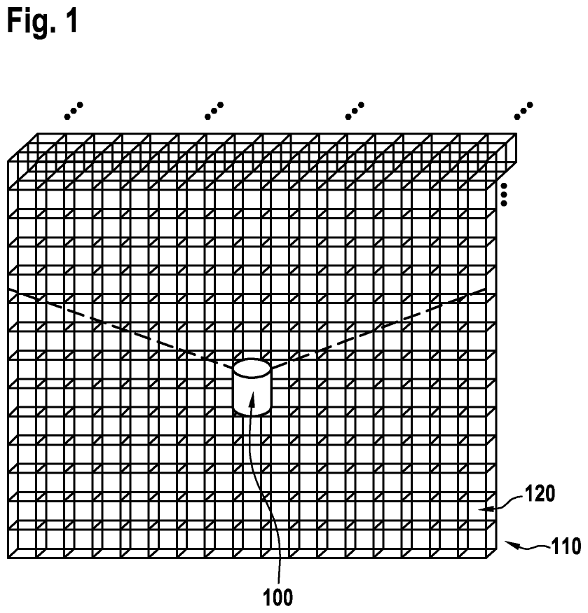

FIG. 1 schematically delineates a three-dimensional grid 110 for the spatial assignment of evaluated detection conditions for particular grid cells 120, with the aid of which the surroundings of a sensor system 100 or a mobile platform, such as a vehicle, is structured. Due to this structure including grid cells 120, evaluated detection conditions may be easily depicted as a function of spatial coordinates. The dashed lines emerging from sensor system 100 delineate a viewing angle of sensor system 100. For example, the three-dimensional grid may have cells of a size of 10×10×10 cm³.

The pieces of information about the presently prevailing evaluated detection conditions may be associated spatially around a vehicle equipped with a sensor system 100 of this type and provided in this form to other systems/modules.

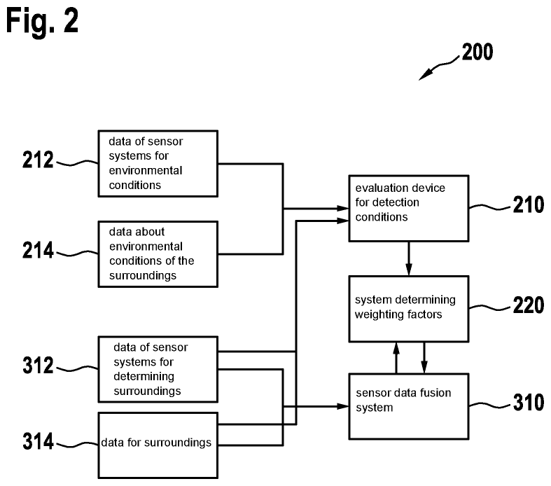

FIG. 2 schematically delineates data flows for determining evaluated detection conditions and their use for the fusion of sensor data to determine surroundings of a sensor system and/or a mobile platform. Data of sensor systems for environmental conditions 212 of the surroundings, data about environmental conditions 214 of the surroundings, data of sensor systems for determining surroundings 312 and data for surroundings 314, for example topographical information and/or map information and/or information made available by other mobile platforms (V2X), represent input data for the evaluation device for detection conditions 210.

The evaluation device for detection conditions 210 provides evaluated detection conditions for an evaluation of sensor data to a system 220, which thus determines and provides weighting factors for a fusion of sensor data of different sensor systems for a sensor data fusion system 310. Sensor data fusion system 310 fuses data from the sensor systems for determining surroundings 312 and the data for surroundings 314.

That means, in other words, that presently prevailing conditions in the surroundings of sensor systems and/or mobile platforms are to be combined from different sensor data and/or data sources relating to environmental conditions and/or surroundings models as bases for determining detection conditions for the purpose of determining evaluated detection conditions. Weights may be determined with the aid of these evaluated detection conditions for the purpose of fusing data from different sensor systems, for example with respect to specific perception characteristics and/or data sources for surroundings of a sensor system and/or a mobile platform having a correspondingly determined weighting for the purpose of determining a surroundings model of the sensor system and/or the mobile platform.

What is claimed is:

1. A method for determining an evaluated detection condition for an evaluation of sensor data, comprising:
providing a first integrity value of the detection condition, based on a first basis for determining the detection condition;
providing a second integrity value of the detection condition, based on a second basis for determining the detection condition;
determining an overall integrity value for the detection condition, based on the first integrity value and the second integrity value; and
assigning the overall integrity value to the detection condition for determining the evaluated detection condition.

2. The method as recited in claim 1, further comprising:
providing a first confidence value of the detection condition, which is based on the first basis for determining the detection condition;
providing a second confidence value of the detection condition, which is based on the second basis for determining the detection condition;
determining an overall confidence value for the detection condition, based on the first confidence value and the second confidence value;
assigning the overall integrity value and the overall confidence value to the detection condition for determining the evaluated detection condition.

3. The method as recited in claim 2, wherein the determination of the overall confidence value is based on a probabilistic combination of the first confidence value and the second confidence value.

4. The method as recited in claim 1, wherein the determination of the overall integrity value is based on an arithmetic function of the first integrity value and the second integrity value.

5. The method as recited in claim 1, wherein the detection condition includes: at least one global detection condition and/or at least one zone-specific detection condition, and/or at least one local detection condition, and/or at least one dynamic detection condition.

6. The method as recited in claim 1, wherein a basis for determining the detection condition is based on data of at least one sensor dedicated to the detection condition, and/or is based on a pattern recognition for the detection condition of data of at least one exteroceptive sensor, and/or is based on a pattern recognition for the detection condition of data of at least two exteroceptive sensors, and/or is based on an evaluation of results of a data processing of at least one sensor, and/or is based on at least one detection condition, which is assigned to geographical data and describes surroundings of a corresponding sensor in greater detail, and/or is based on an evaluation of map topographies, and/or is based on data provided by road users in the surroundings of the corresponding sensor.

7. The method as recited in claim 1, wherein the determination of the evaluated detection condition excludes confidence values and/or integrity values of the detection condition, whose particular basis has a critical dependency on the detection condition.

8. The method as recited in claim 1, wherein the evaluated detection condition is spatially assigned to a representation of surroundings of a sensor system.

9. A method for fusion of data of a first sensor system and data of a second sensor system, comprising:
determining at least one evaluated detection condition for the first sensor system and/or the second sensor system by:
providing a first integrity value of the detection condition, based on a first basis for determining the detection condition,
providing a second integrity value of the detection condition, based on a second basis for determining the detection condition,
determining an overall integrity value for the detection condition, based on the first integrity value and the second integrity value, and
assigning the overall integrity value to the detection condition for determining the evaluated detection condition; and
evaluating the data of the first sensor system and the data of the second sensor system, based on the at least one evaluated detection condition, for the fusion of the data of the first sensor system and the data of the second sensor system to determine a representation of surroundings of at least one of the two sensor systems.

10. The method as recited in claim 9, wherein the data of the first sensor system and the data of the second sensor system are weighted, based on the at least one evaluated detection condition for representing the surroundings.

11. A method, comprising:
determining an evaluated detection condition for an evaluation of sensor data, by:
providing a first integrity value of the detection condition, based on a first basis for determining the detection condition,
providing a second integrity value of the detection condition, based on a second basis for determining the detection condition,
determining an overall integrity value for the detection condition, based on the first integrity value and the second integrity value, and
assigning the overall integrity value to the detection condition for determining the evaluated detection condition; and
based on the determined evaluated detection condition, providing a control signal for activating an at least semi-automated vehicle and/or providing a warning signal for warning a vehicle occupant.

12. An evaluation device for at least one detection condition, which is based on a multiplicity of bases for determining the detection condition, the evaluation device comprising:
a calculation unit configured to determine an evaluated detection condition for an evaluation of sensor data, the calculation device configured to:
provide a first integrity value of the detection condition, based on a first basis for determining the detection condition,
provide a second integrity value of the detection condition, based on a second basis for determining the detection condition,
determine an overall integrity value for the detection condition, based on the first integrity value and the second integrity value, and
assign the overall integrity value to the detection condition for determining the evaluated detection condition.

13. The evaluation device as recited in claim 12, wherein the evaluation device is configured to be used for fusion of data of a first sensor system and data of a second sensor system for determining a representation of surroundings of at least one of the first and second sensor systems.

14. A non-transitory machine-readable memory medium on which is stored a computer program for determining an evaluated detection condition for an evaluation of sensor data, the computer program, when executed by a computer, causing the computer to perform the following steps:
providing a first integrity value of the detection condition, based on a first basis for determining the detection condition;
providing a second integrity value of the detection condition, based on a second basis for determining the detection condition;
determining an overall integrity value for the detection condition, based on the first integrity value and the second integrity value; and
assigning the overall integrity value to the detection condition for determining the evaluated detection condition.
